(19) United States
(12) Patent Application Publication
(10) Pub. No.: US 2016/0329113 A1
(43) Pub. Date: Nov. 10, 2016

(54) SLIMM-Scalable Liquid Metal Cooled Small Modular Reactor

(71) Applicant: STC.UNM, Albuquerque, NM (US)

(72) Inventor: Mohamed S. El-Genk, Albuquerque, NM (US)

(73) Assignee: STC.UNM, Albuquerque, NM (US)

(21) Appl. No.: 15/102,169

(22) PCT Filed: Dec. 5, 2014
(86) PCT No.: PCT/US2014/068910

§ 371 Date: Jun. 6, 2016

Related U.S. Application Data
(60) Provisional application No. 61/913,097, filed on Dec. 6, 2013.

(51) Int. Cl. G21C 15/12; G21C 3/06; G21D 3/04; G21C 1/32; G21C 3/32

(52) U.S. Cl. CPC G21C 15/12; G21C 1/322; G21C 3/32; G21D 3/04; G21C 3/06; G21Y 2004/305; G21Y 2004/30

(57) ABSTRACT

The present invention provides a modular nuclear reactor system comprising a reactor pressure vessel having a lower section having a first wall and a second wall and an upper section having a first wall and a second wall. The reactor includes a chimney with an attached heat exchanger. First and second passageways create a circulation loop wherein heated heat transfer fluid circulates up from the reactor core, through the chimney, through an upper plenum and downwardly past the heat exchanger, into a lower plenum and back into the core.

### RELATED APPLICATIONS

This application claims priority to and the benefit of the filing date of U.S. provisional application Ser. No. 61/913,097 filed Dec. 6, 2013 and incorporated herein for all purposes.

### BACKGROUND OF THE INVENTION

Small modular nuclear reactors (SMRs) offer specific attributes that make them attractive for remote and isolated communities with limited/seasonable access to fossil fuel supplies, to countries with small electric grid capacity, and island nations with no or limited access to an electric grid. SMRs are also an attractive option to electric utilities operating in regions with modest growth in electricity demand and/or modest financial resources.

All or most components of SMRs, depending on the installed electrical power of the plant, are built in the factory. They are small enough to be shipped to the site by rail, truck or on a barge. During nominal operation and after shutdown, SMRs can be designed to operate fully or partially passive with no or a few circulation pumps and redundant means for removing the decay heat generated in the reactor core after a routine or an emergency shutdown. These reactors can also be designed with long operation lives of 5-10 years, or even longer, without refueling.

Small modular nuclear reactors can provide for up to 300 MWe of electricity. In highly populated and industrial areas, the cost of electricity generation using SMRs may not be comparable to, or lower than that of medium (>300 and <1000 MWₑ) and large (>1000 MWₑ) nuclear power plants.

A typical large nuclear plant provides 1,000-1,500 MWe at a capital cost of $6 B-$10 B and takes 5-6 years to build. A SMR plant with an installed capacity of ˜300 MWe at cost <$2 B takes ˜18 months to build. A 10 MWe SMR plant may take only 6 months or less to bring on line at a cost of ˜$80 M. In addition to design simplicity and partial or fully passive operation and safety features, an SMR vessel typically has few penetrations, and some have an in-vessel compact steam generator or heat exchanger. Large nuclear plants typically require emergency planning zones of up to 10 miles in radius, while those for SMRs are <0.5 miles.

SMRs are constructed and brought on line incrementally in future years, commensurate with the increase in electricity demand. This avoids the financial obligations associated with building a large plant, the need to develop a consortium of multiple utilities in more than one state, the interest on a large loan ($6 B-10 B) for ˜5-6 years of the construction time, and the lack of revenues during these years. SMRs offer simple designs with partial or fully passive operation and safety features. During nominal operation and after shutdown, SMRs are safely cooled by natural convection or using a few circulation pumps. They also have redundant and passive means for removing decay heat generated in the reactor core after a routine or an emergency shutdown. They are designed to survive a loss of both onsite and off-site power for weeks, without compromising safety. SMRs may offer independent and passive means for generating auxiliary power to support vital plant functions, in the unlikely event of a Fukushima-Daiichi type accident.

Many SMRs have thermal neutron spectra, but only a few are being developed with fast neutron spectra. Those with thermal spectra have an operation cycle length between refueling of 1-5 years. By contrast, fast neutron spectrum SMRs are smaller in size and may operate for decades without refueling and effectively minor actinides. The light water moderated and cooled SMRs with thermal spectra capitalize on the existing technology base and long and successful experience operating large Light Water Reactors (LWRs) and use low fuel enrichment <5%.

These SMR designs offer a number of passive operation and safety features. Because of their thermal energy spectra, they minimally reduce minor actinides in used fuel, which could effective in fast spectra reactors.

High temperature gas cooled HTG-SMRs with epithermal or fast neutron spectra for burning minor actinides operating at exit temperatures up to 1000-1200 K are considered or actively being developed for a near term deployment. In addition to the high thermal efficiency (>40%) for electricity generation, the HTG-SMR plants with a hybrid operation provide for thermochemical production of hydrogen fuel and process heat for a multitude of industrial uses. The HTG-SMR designs, which effectively burn actinides and utilize used fuel from LWR plants, are well known.

The sodium cooled SMRs with fast neutron spectra, are not only the smallest but also effective in destroying minor actinide during reactor operation. The ratio of fission to capture cross sections is higher than in reactors with thermal or epithermal energy spectra. Owing to the low vapor pressure of sodium coolant, SMRs operate at relatively high exit temperatures (<850 K), plant thermal efficiency close to 40%, and below atmospheric pressure. By contrast, light water SMRs operating at high pressures of 5-15 MPa, require a massive reactor vessel and operate at a lower plant thermal efficiency of 30 to 33%. The potential of other liquid metals (molten lead or lead-bismuth) cooled and molten salt cooled SMRs are also being investigated.

### BRIEF SUMMARY OF THE INVENTION

In one embodiment, the present invention is directed toward a sodium-cooled, small modular reactor capable of generating tens of MWth and has a long operation life without refueling. The reactor of the present invention includes an in-vessel coiled tube Na/Na heat exchanger (HEX) and two redundant control/shutdown systems. It may be fabricated, assembled and sealed at the factory and shipped to the site by rail, a heavy truck or on a barge. It is installed below ground to alleviate a missile or a spacecraft impact and mounted onto seismic insulators to withstand Earthquakes.

In another embodiment, the present invention uses natural circulation of liquid sodium with the aid of in-vessel helically coiled tubes, Na/Na HEX, and a chimney to cool the fast neutron spectrum of the reactor during nominal operation and after shutdown. The design uses a fuel rod cladding, core structure and fuel materials, operates below 820 K and has two redundant control and emergency shutdown systems. It operates fully passive, except for the control drives, uses rods of UN fuel with enrichment less than 18% in the driver core, and has radial and axial blankets of depleted UN (DUN). Other embodiments may use a BeO reflector blanket to reduce or lower fuel enrichment. The high heavy metal atom ratio of UN increases the operation cycle length without refueling. The UN has good retention of fission gasses and its high thermal conductivity typically keeps the temperatures of the UN fuel in the reactor core below 1400 K. These inherent characteristics minimize or eliminate concerns of fuel swelling and fission gas release and enhance safety and fuel performance for a long operation life of the reactor.

In yet another embodiment, the reactor core has two redundant control systems with separate drives, one for safety shutdown and the other controls the reactor operation. Each system is capable of shutting down the reactor in case of an emergency. Both safety shutdown systems may consist of enriched B₄C control rods, with BeO followers.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIGS. 1A and 1B are radial cross-sectional views of a reactor core used in an embodiment of the present invention taken across section line B-B in FIG. 4.

FIGS. 2A and 2B show cross-sections of a central safety shutdown assembly for an embodiment of the present invention with FIG. 2A taken at line B-B of FIG. 2B and FIG. 2B taken across section line A-A of FIG. 2A.

FIGS. 3A and 3B show cross-sectional views of a fuel rod used in an embodiment of the present invention with FIG. 3A taken across section line A-A of FIG. 38 and FIG. 3B taken across section line B-B of FIG. 3A.

FIG. 4 is a longitudinal cross-section of a reactor for an embodiment of the present invention.

FIG. 5 is a chart illustrating the operation surface of the reactor parameters with liquid sodium natural circulation for some embodiments of the present invention.

FIG. 6 is a cross-sectional view showing an embodiment of the present invention installed in a retaining system.

FIG. 7 is a pie section of a reactor for an embodiment of the present invention.

FIG. 8 is chart illustrating reactor core nominal power densities for some embodiments of the present invention.

FIGS. 9-10 are radial cross-sectional views of reactor cores used in other embodiments of the present invention.

FIG. 11 is a chart illustrating the effect of chimney height on reactor power for some embodiments of the present invention.

FIG. 12 is chart illustrating the effect of UN fuel enrichment on excess reactivity and shutdown margin for some embodiments of the present invention.

FIGS. 13A and 13B are charts illustrating the effect of follower rod materials in control systems on reactivity and cold-clean shutdown margin for some embodiments of the present invention.

FIG. 14 is a chart illustrating the effect of the material of radial blanket corner assemblies on hot-clean reactivity and cold-clean reactivity shutdown margins for some embodiments of the present invention.

FIG. 15 is a chart illustrating core barrel HT-9 steel reactivity worth for some embodiments of the present invention.

FIG. 16 is a chart illustrating the effect of BeO shrouds on the fuel assemblies in a reactor driver core for some embodiments of the present invention.

FIGS. 17A and 17B are charts illustrating neutron energy spectra in a reactor core for some embodiments of the present invention.

FIG. 18 is a chart illustrating reactor operation life estimates for some embodiments of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

The reactor design of the present invention takes advantage of the high heavy metal atom ratio, high melting point and high thermal conductivity of UN fuel and uses HT-9 steel for cladding, reactor vessel and core structure. It may be fabricated, assembled and sealed offsite such as in a factory, shipped to the construction site by rail, heavy truck or barge and installed below ground on seismic insulators. Natural circulation of liquid sodium cools the reactor core during nominal operation and after shutdown using in-vessel helically coiled tubes such as a Na/Na heat exchanger (HEX). In other embodiments, other known heat exchangers may be used as well. It also estimates the operation life of the reactor in full power mode (100 MWth of six years and as much as 34 years at 20 MWth.

The reactor of the present invention operates fully passive, except for the control drives, uses UN fuel with enrichment <18% in the driver core with radial and axial blankets of either depleted uranium nitride (DUN) or BeO. The high thermal conductivity of UN decreases fuel temperatures during nominal operation below 1400 K, depending on the reactor thermal power. At such temperatures, fuel swelling and fission gas release are non-issues. In addition to its compatibility with the HT-9 and liquid sodium, UN has a higher volumetric heat capacity than UO₂ and U-metal fuels for enhanced safety.

In addition to the high heavy metal ratio for long operational life of the reactor, the UN high thermal conductivity, ˜10 times that of UO₂, decreases the maximum UN fuel temperature during nominal reactor operation. The UN fuel is compatible with the HT-9 cladding and with sodium coolant at the operation temperatures of the reactor (<820 K).

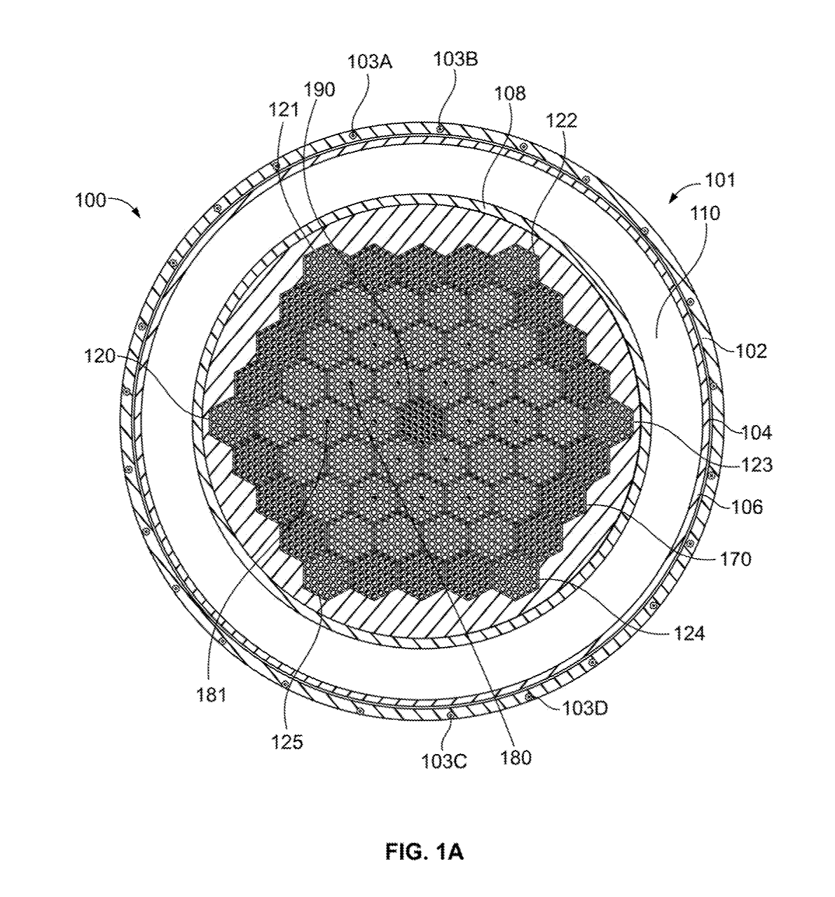

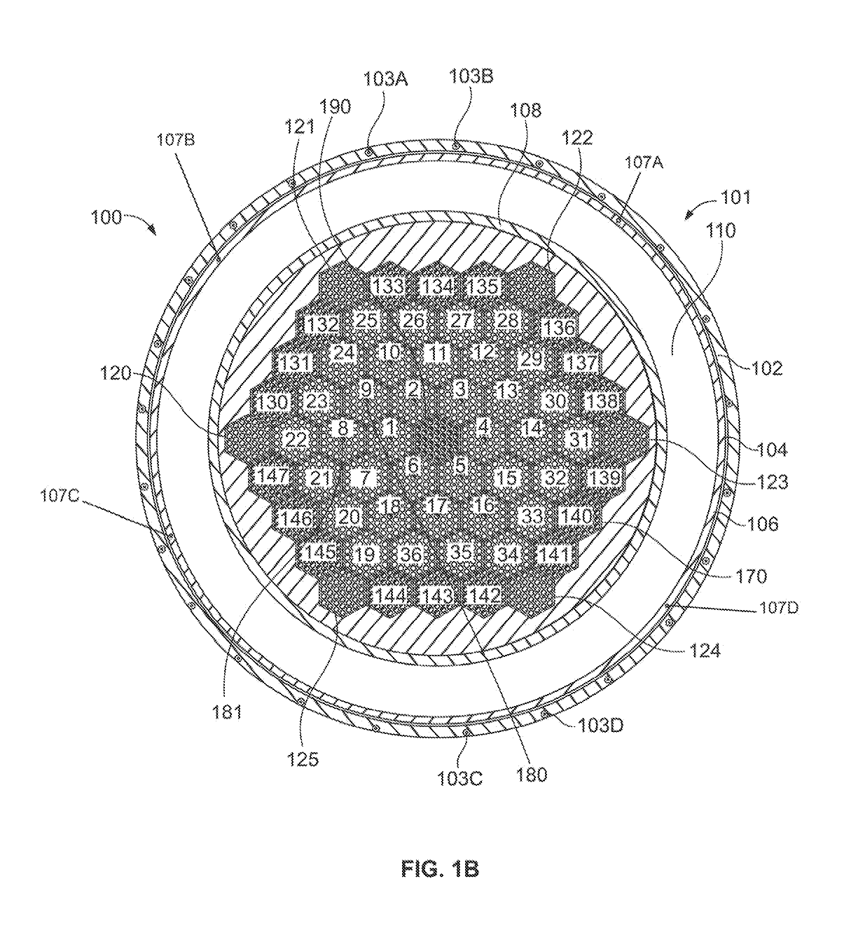

As shown in FIGS. 1A and 1B, reactor 100 may include an outer vessel 101 comprised of outer wall 102 and inner vessel wall 104 which is a spaced distance from outer wall 102 to form gap 106 which may be filled with argon. A plurality of heat pipes, 103A-103D and 107A-107D, may be configured to provide variable conductance, are located in walls 102 and 104. While pipes 103A-103D and 107A-107D are designated, one or more pipes may be used in accordance with the preferred embodiments of the present invention. Core wall or barrel 108 is spaced inwardly from inner wall 104 to form another gap 110 which may be filled with a cooling medium.

As further shown in FIGS. 1A and 1B, reactor 100 contains a plurality of fuel rods 1-36. In a preferred embodiment, thirty six UN fuel rods are bundled in the reactor core in hexagonal assemblies with scalloped BeO shrouds. The UN fuel assemblies may be located in three concentric rings; UN fuel assembles 1-6 make up the first ring, UN fuel assemblies 7-18 make up the second ring and UN fuel assemblies 19-36 make up the third ring as shown in FIG. 1. One or more fuel assemblies may include control rods which may be B₄C/BeO followers. The control rods may be located in the center of the assembly where rod 50 is located as shown by the exemplary control rods 180 and 181 in FIG. 1A.

Fuel assemblies 1-36 may be retained by hexagonal corner assemblies 120-125 which may be made of steel or BeO rods. A hexagonal cladding may also be used. Also surrounding and retaining the fuel assemblies are blanket assemblies 130-147 which may be comprised of rods containing depleted (DUN) fuel or BeO pellets. As further shown in FIG. 1, the core may include a hexagonal shutdown drive 190 which is located at the center of the core.

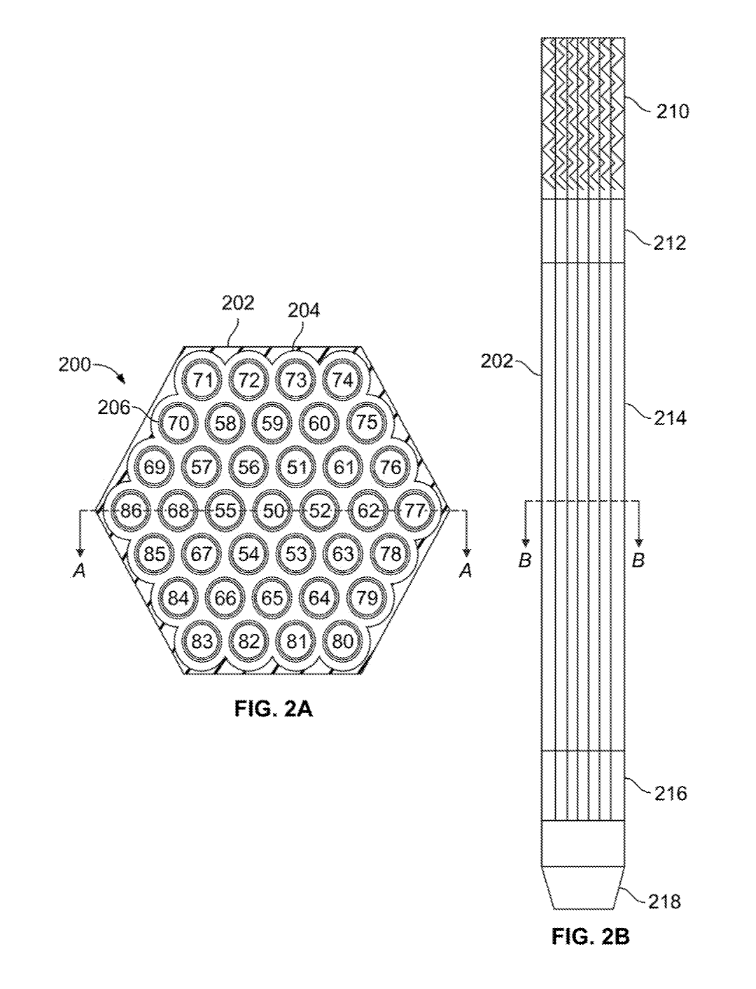

FIGS. 2A and 2B show the design of fuel assembly 200 used with an embodiment of the present invention which may be used to construct the fuel assemblies 1-36 described above. In addition, the general structural arrangement of assembly 200 may be used with the other assemblies of the present invention such as assemblies 120-125 and 130-147.

As shown in FIGS. 2A and 2B, assembly 200 may be loaded with UN fuel rods 50-86 which are retained by wall 202 which may be a BeO wall that includes scallops 204. Scallops 204 are configured to provide equal flow area per rod, including the edge and corner rods. Each fuel road may be surrounded with HT-9 steel cladding 206. The fuel rods may be 2.357 cm in diameter and arranged in a triangular lattice with a Pitch-to-Diameter (P/d) ratio of 1.2. The low parasitic neutron absorption in BeO, compared to HT-9 steel and the beryllium's neutrons moderation and production by the (n,2n) and (g,n) reactions increase the hot-clean reactivity of reactor 100. This increases the refueling cycle estimated to be more than 6 and 34 years at 100 MWₜₕ, and 20 MWₜₕ, respectively.

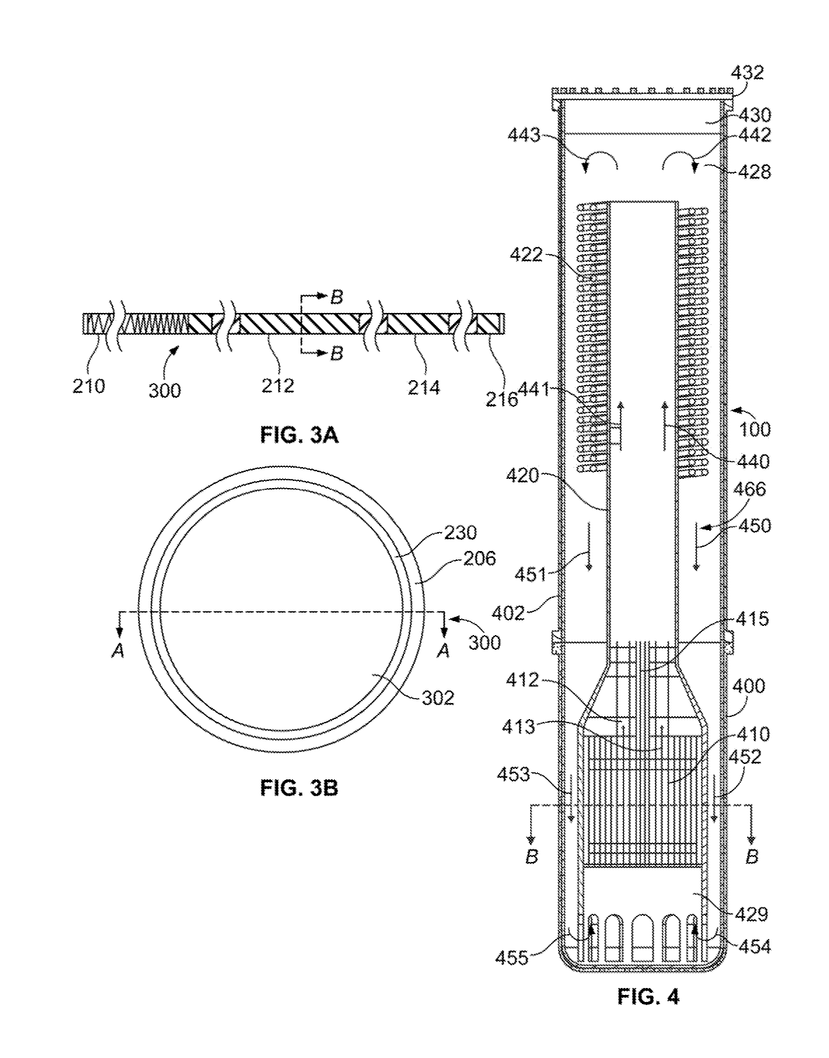

The fuel rods have an upper gas plenum 210 section for accommodating released fission gasses, sections of axial blankets of depleted (DUN) or BeO pellets 212 and 216, and fuel section 214. As shown in FIGS. 3A and 3B, fuel rod 300 comprises fuel pellet 302 surrounded by an annular sodium-filled radial gap 230, which, in turn is surrounded by wall 206, which may be a HT-9 cladding.

As shown in FIG. 1, reactor 100 includes a fourth ring that may be comprised of DUN assemblies 130-147. Each DUN assembly may have HT-9 scalloped walls that serve a cladding for the DUN rods. The ring also encompasses corner assemblies 120-125 which may be loaded with HT-9 steel rods and HT-9 shrouds or cladding with scalloped walls. As also shown, core barrel 108 includes HT-9 steel wedges 170 which retain the assemblies. The wedges also reflect neutrons leaking out of the core.

As described above, using hexagon assemblies allows for the creation of rings of assemblies that may be interlocked together. In a preferred embodiment, each assembly uses the same hexagonal frame or housing which allows for the assemblies to be mated together into hexagonal rings or units. For example, assemblies 1-6 form a first hexagonally-shaped ring around assembly 190. Assemblies 7-18, in turn, form a second hexagonally-shaped ring around assemblies 1-6. Assemblies 19-36, in turn, form a third hexagonally-shaped ring around assemblies 7-18. Assemblies 120-125 and 130-147, in turn, form a fourth hexagonally-shaped ring around assemblies 19-36. Lastly, a retaining wall 108 having wedges 170 locks the assemblies together.

As shown in FIG. 4, the primary and guard vessels of reactor 100 are made of two sections 400 and 402. Lower section 400 houses core 410, control drives 412-413, and safety shutdown drive 415. Upper section 402 houses chimney 420 and the in-vessel, helically coiled tubes 422, which may be a Na/Na HEX. The heights of chimney 420, HEX 422, and upper section 402 depend on the reactor thermal power. The walls of the primary and guard vessels are only a few inches thick. The vessels are each capable of fully containing the reactor core, liquid sodium and in-vessel components.

FIG. 4 also shows other components of reactor 100; they are upper plenum 428, lower plenum 429, and chamber 430 which is located below vessel head 432. Chamber 430 may be filled with argon gas. Chamber 430 may also be adapted to permit the Argon gas to be replaced with liquid sodium to increases the gap conductance thereby enhancing removal of decay heat from the reactor core.

Also shown is the placement of Na/Na HEX 422 and the natural circulation paths of heated liquid sodium. The paths are indicated by arrows 440-443 and cooled liquid sodium is indicated by arrows 450-455.

The internal pressure in the reactor vessel is kept slightly below atmospheric, owing to the low vapor pressure of the sodium. Thus, the steel reactor vessel wall is only a few inches thick. In a preferred embodiment, the pressure of the argon cover gas is slightly below atmospheric and the total pressure at the bottom of the reactor vessel is less than 2.0 MPa, depending on the chimney height.

In-vessel natural circulation of liquid sodium cools the reactor core during nominal operation and after shutdown, with the aid of chimney 420 and in-vessel HEX 422. The difference between the static pressure head of sodium in downcomer 466 and the sum of those in the core and the chimney drives the natural circulation of liquid sodium through the core. The circulating liquid sodium removes and transports the fission or the decay heat generated in the core to HEX 422 near the top of downcomer 466. The cooled sodium flows downward to lower plenum 429 before entering the reactor core to repeat the cycle.

In another embodiment using the same core design and having an inlet temperature of liquid sodium at the core of about 610 K, increasing the chimney height increases the nominal thermal power of the reactor and the temperature of liquid sodium exiting the core, which remains <820 K. At these temperatures, corrosion of HT-9 for the fuel rods cladding and core structure by liquid sodium is negligible. In another embodiment, the sodium vapor pressure at its exit temperature from the core during nominal reactor operation is very low at about 1.6 kPa. This provides a large safety and operation margin to boiling incipience.

Leak and radiation detectors are also placed in the gap between the inner and outer vessels for monitoring reactor operation. Each vessel is capable of containing the reactor core and the internal structure and components.

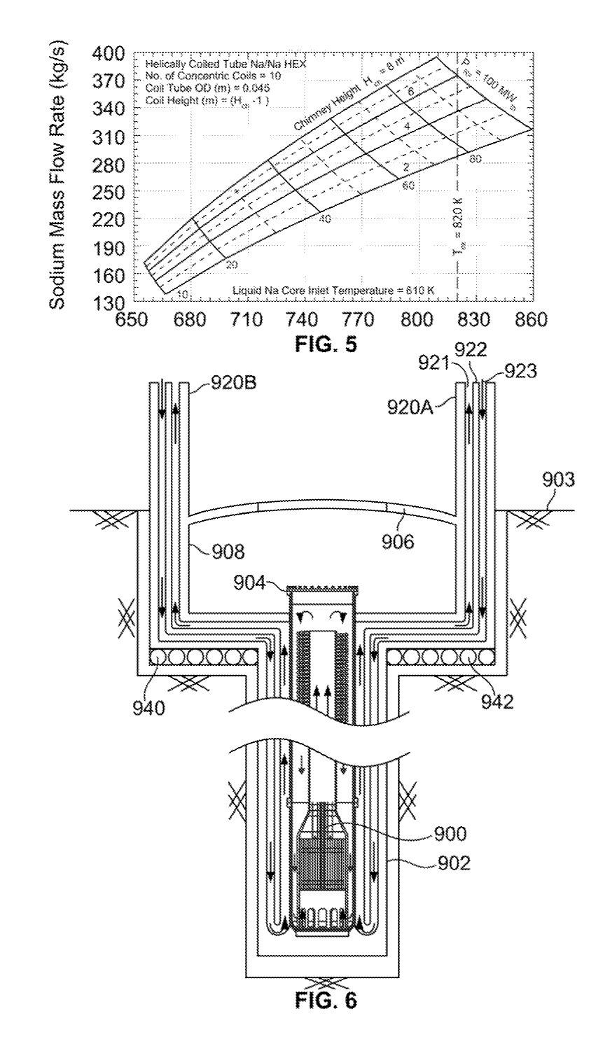

As indicated earlier, Na/Na HEX 422 removes the reactor thermal power during nominal operation and the decay heat after shutdown. The heat removed from the circulating liquid sodium in the reactor vessel is transported to one or more steam generators (not shown) in a superheated steam Rankine cycle that produces electricity at a plant thermal efficiency of up to 40% or even higher. Nominal electrical power and the thermal efficiency of the reactor plant depend on the operating reactor thermal power and the temperature of the liquid sodium coolant exiting the reactor core as shown in FIG. 5.

FIG. 5 presents an example of a performance surface of the reactor with a Na/Na HEX comprised of ten concentric helically coiled tubes (4.5 cm OD). The performance surface is a grid of curves of the flow rate of liquid sodium versus its exit temperature in the core for different chimney heights and intersecting curves of the reactor thermal power. The results are from the solution of the coupled overall momentum and energy balance equations for the liquid sodium flow in the reactor vessel by natural circulation.

The solution assumes a constant sodium inlet temperature into the core of 610 K, which may be varied to change the temperature rise in the core. The pressure losses in the momentum balance equation include those in the core, chimney, Na/Na HEX and the rest of the downcomer. They also account for the changes in the flow area in the various regions. The highest-pressure losses are those calculated in the reactor core followed by those in the helically coiled tube Na/Na HEX and then the chimney. For a reactor power of 10 MWₜₕ the temperature of liquid sodium exiting the core decreases from ˜667 to only 655 K as the chimney height increases from 2 to 8 m. For a reactor power of 100 MWₜₕ a chimney that is at least 6 m tall keeps the temperature of the sodium exiting the core at or below 820 K. This temperature decreases to 809 K when the chimney height increases to 8 m. At these temperatures, sodium corrosion of the HT-9 cladding, core structure and reactor vessel is negligible.

FIG. 6 shows a containment system that may be used with some embodiments of the present invention. As shown, reactor 900 is contained in silo or housing 902 which may be made of concrete and configured to retain the reactor below ground level 903. Vessel head 904 may be located above ground level inside a containment dome 906 having a steel liner 908. Air stacks 920A and 920B include hot air exhaust duct 921 and cold air intake duct 922 which are separated by insulating divider 923. A plurality of seismic oscillation bearings 940 and 942 may also be used to secure the reactor.

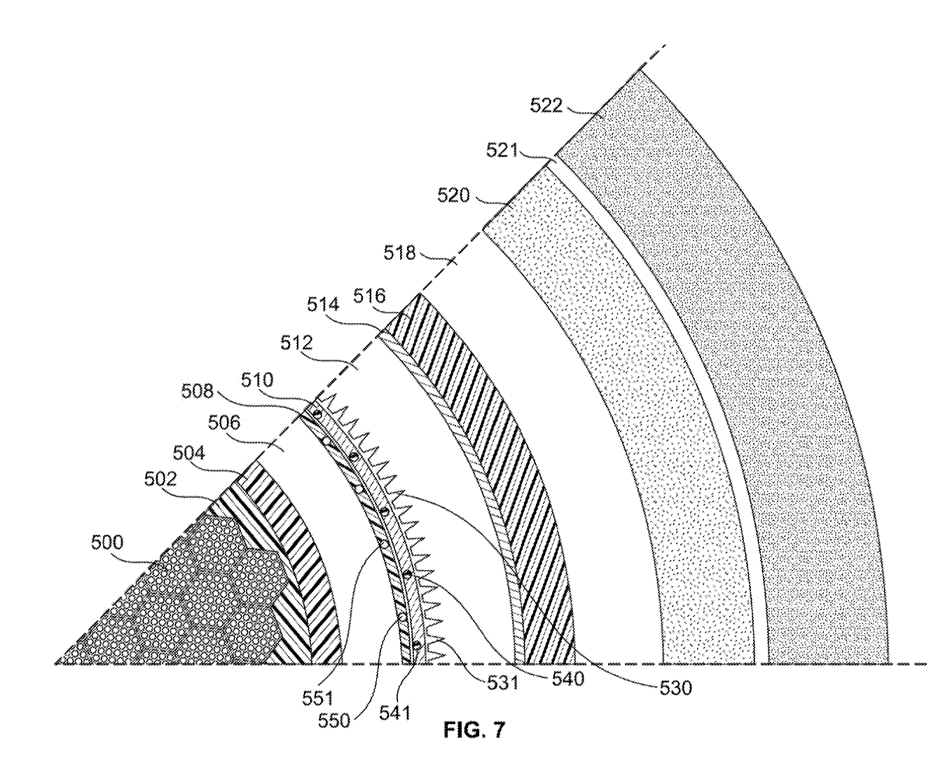

FIG. 7 shows another embodiment of a reactor and containment system of the present invention. As shown in cross-section, the components of this embodiment of the present invention may arranged from inside to outside as follows: reactor core 500, steel wedging 502, core barrel 504, downcomer 506, reactor inner vessel 508, reactor guard 510, reactor outer vessel 512, steel liner 514, thermal insulation 516, cold air intact duct 518, cold air intake duct wall 520, hot air exhaust duct 521 and silo or housing 522. As is also shown, a plurality of fins 530-531, spreader water heat pipes 540-541 and variable conductance pipes 550-551 may also be provided to increase the heat transfer efficiency of the reactor.

As described above, during nominal reactor operation and after shutdown, liquid sodium continues to flow by natural circulation through the core and the chimney and downward in the downcomer separating the core barrel from the reactor vessel. The low thermal conductivity of the inert argon gas that fills gap or chamber 430 of the embodiment shown in FIG. 4 between the reactor's primary and the guard vessels reduces side heat losses during nominal reactor operation. In addition, chamber 430 may have highly reflective facing walls, which further decrease heat losses. The installed detectors in this gap monitor the reactor during nominal operation and detect any sodium leak through the primary vessel wall.

To further reduce heat losses, the reactor may include an above ground vent on the outside surface of the guard vessel which remains shut. The vent may be configured to open only intermittently when the air heats up and expands against the weight of the vent cover.

The variable conductance, liquid metal heat pipes 130A-130D in the reactor vessel wall may be configured to capture some of the side heat losses, both during reactor operation and after shutdown, and transport it to an offsite location such as containment building for other uses. There, it may be partially converted to electricity using static modules comprised of segmented TE elements. The modules may be made of a number of parallel strings of TE elements for redundancy and avoidance of a single point failure. The TI: modules generate kilowatts of electrical power at relatively high voltage of ˜200-400 VDC. They serve as an auxiliary power source for operating critical functions of the plant, particularly in the unlikely event of a loss of both onsite and offsite power. The waste heat removed from the cold side of the TE modules by natural circulation of ambient air. This passive design feature not only enhances reactor and power plant safety, but also increases the total thermal power utilization for the plant.

In yet another preferred embodiment, the reactor is modular and fabricated, fully inspected and assembled and sealed at an offsite location such as a factory, enhancing the quality assurance and reliability of the reactor. It may be shipped to the site by a truck, rail or on a barge, with the coolant frozen prior to shipping so as to prevent coolant from moving during transport. Th reactor may be installed below grade and brought on line within a short time <12 months, depending on the nominal reactor thermal power. At the end of its operational life, which may be several years to decades, the reactor units may be replaced with new ones, in a relatively short period of time, which may be as little as days. The used units may then be shipped back to the vender for fuel reprocessing in a safe and secure facility, thus eliminating proliferation concerns.

The reactor design of the present invention takes advantages of the high heavy metal atom ratio, high melting point and high thermal conductivity of UN fuel and uses stainless steel for the fuel rod cladding and the reactor core structure and a steel vessel. As a result of the modularity, with the same reactor core design, materials and dimensions, the nominal thermal power of the reactor increases simply by increasing the height of the chimney up to 8 m, while keeping the temperature of liquid sodium coolant entering the core the same temperature of about 610 K. The increased chimney height increases the circulation rate of liquid sodium through the core as well as its exit temperature. The exit temperature generally remains below 820 K to maintain a negligible corrosion rate of the HT-9 steel components such as the cladding of the UN fuel rods and core structure materials. The low reactor thermal power density increases its operation life and together with the high thermal conductivity of UN fuel, decreases its temperature during nominal reactor operation. Such low temperature results in negligible fuel swelling and fission gas release, consistent with the long operation life of the reactor without refueling.

In additional embodiments of the present invention, the reactor core has a negative temperature reactivity feedback that helps passive shut down in case of a large temperature rise. The reactor operation is monitored using two redundant systems, each with separate drivers; the safety shutdown (190 in FIG. 1 and 415 in FIG. 4) and reactor control systems (180 and 181 in FIG. 1 and 412 and 413 in FIG. 4). Each of these systems is capable of shutting down the reactor in case of an emergency. As shown in FIG. 1, the safety shutdown system consists of a single hexagonal assembly 190 of enriched B₄C rods with BeO followers. This assembly may be located at the center of the reactor core.

Reactor control systems 180 and 181 include enriched B₄C rods with BeO followers which may be located in the fuel assemblies described above. In a preferred embodiment, the rods are inserted at the center of fuel rod assemblies which may be in place of rod 50 that is shown in FIG. 2A. In another preferred embodiment, enriched B₄C rods with BeO followers are located in assemblies 1-6 and in assemblies 8-10, 12-14, and 16-18 of FIG. 2A. The enriched B₄C rods with BeO followers, which are of the same diameter as the UN fuel rods, are used to start up and shutdown the reactor and to adjust reactivity during nominal operation. When fully inserted into the core, the rods may safely shutdown the reactor, independent of safety shutdown assembly 190. Similarly, in case of an emergency, safety control assembly 190, when fully inserted, safely shuts down the reactor, irrespective of the reactor control system described above. At startup, the B₄C rods in central control assembly are fully withdrawn from the core, with the BeO follower rods in the center cavity of the core. The reactor is brought to criticality by incrementally withdrawing the B₄C rods at the center of the fuel rod assemblies in the first ring by assemblies 1-6 and in the second ring of the reactor core by assemblies 8-10, 12-14, and 16-18.

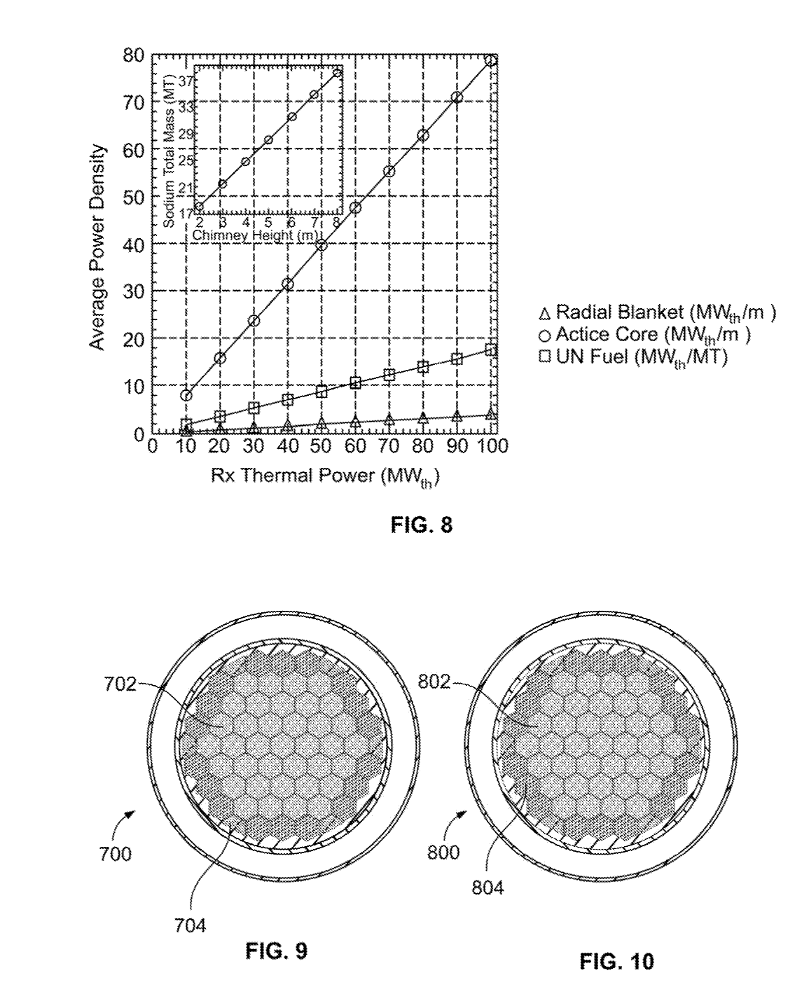

After a reactor shutdown, the coiled tube Na/Na heat exchanger continues to remove the decay heat generated in the reactor core, and some of the sensible heat of the liquid sodium in the reactor vessel, decreasing its temperature with time after shutdown. The large mass of liquid sodium in the reactor vessel serves as a huge heat sink, enhancing safety by limiting the initial increase in its temperature shortly after reactor shutdown. In a preferred embodiment, the liquid sodium mass increases with the height of the chimney, from 18 MT to 38 MT as the chimney height increases from 2 m to 8 m as shown in FIG. 8. During nominal operation, the average power density in UN fuel of the driver core increases from ˜1.8 to 17.6 MWₜₕ/MT as the reactor thermal power increases from 10 to 100 MWₜₕ as shown in FIG. 8. For the same reactor powers, the core's average power density increases from 8 MWₜₕ/m³ to 79 MWₜₕ/m³, respectively. These power densities decrease about orders of magnitude immediately after reactor shutdown. In case of an unlikely malfunction of the in-vessel Na/Na HEX, the reactor shuts down and natural circulation of ambient air removes the decay heat with the aid of the variable conductance heat pipes along the walls of the primary and secondary vessels. With a functioning Na/Na HEX natural circulation of air is suppressed by keeping the above ground vent of the hot air riser on the outside of the guard vessel shut. It opens intermittently as the air in the riser heats up and expands against the weight of the vent cover.

In the unlikely event of a malfunction, the two redundant control systems may be used to shut down the reactor using either system or both systems. In addition, the reactor core negative temperature reactivity feedback limits potential power increase and help reactor shutdown. The decay heat generated in the reactor core after shutdown is removed safely and passively by a backup system of natural circulation of ambient air on the outside of the guard vessel wall. Replacing the argon gas in the small gap between the reactor vessel and the guard vessel with liquid sodium increases the gap conductance, thus enhancing the decay heat removal from the reactor core. Initially, the decay heat is partially stored in the large sodium mass within the reactor vessel. It is also transferred by conduction from the reactor vessel to the guard vessel wall, which has longitudinal metal tins, where removed by natural circulation of ambient air.

In addition, within a few days after shutdown, depending on the reactor nominal power before shutdown, natural circulation of air alone is capable of removing all the decay heat generated in the core and some of the sensible heat stored earlier by the liquid sodium in the vessel, gradually lowering its temperature. The maximum temperature of liquid sodium in the vessel after reactor shutdown remains below its boiling point. The decay heat removal from the reactor guard vessel is aided by the array of variable conductance heat pipes 103A-103D located in the reactor vessel wall as shown in FIG. 1. Other heat removal means include longitudinal metal tins 530-531 and heat pipes spreaders 540-541 along the outer surface of guard vessel 510 as shown in FIG. 7. The variable conductance heat pipes may also be used to recover the heat losses from the reactor vessel and transport it to thermoelectric modules in the reactor containment. These modules partially convert the thermal energy transported by the heat pipe to electricity for operating instrumentation and control council and providing auxiliary power in case of an off-site and on-site loss of power.

Owing to the negative temperature reactivity feedback of the reactor core, the plant is inherently load following. Thus, it accommodates a change in the load demand, as a percentage of the nominal reactor power without active control. In addition to the enhanced reliability, this design feature increases the plant's availability or capacity factor. Table I below lists the primary features of some embodiments of the reactor of the present invention and power plant performance.

TABLE I
Design and Operation Features of SLIMM Reactor and Plant.

| Parameter | Preliminary Estimate/Comments |
|---|---|
| Rx Power (MWth) | <150 |
| Elec. Power (MWₑ) | 3-60 |
| Fabrication& Assembly | In factory |
| Transportation | By Truck, Rail or Barge with coolant |
| | frozen |
| Modularity | Same Rx core design &variable chimney |
| | and Rx vessel height |
| Coolant | Liquid Sodium |
| Na Inlet/Exit Temp. (K) | 610/<820 |
| Rx Cooling | Na Natural circulation |
| Decay heat removal | Primary: Na natural circulation and |
| | in-vessel Na/Na HEX |
| | Backup: Ambient air natural circulation |
| Const. Time (Mons) | 6-18 |
| Reactor Control | Safety shutdown: Central B₄O |
| | assembly |
| | Rx Control: 15 B₄C central rods |
| | in fuel assemblies |
| Additional Cooling | Variable conductance liquid metal heat |
| | pipes in Rx vessel and water heat pipes |
| | in guard vessel |
| Auxiliary Power | Redundant TE modules with variable |
| | conductance heat pipes |
| | (>60%): Electrical power, space heating, |
| | auxiliary power, heat for |
| Energy Utilization | industrial uses and seawater desalination |
| Fuel Material | UN, <18% Enrichment |
| Fuel Rods Cladding & | HT-9 steel |
| Core Structure | |
| Plant Cooling | Water or dry Air |

The rate of decay heat generation in core at shutdown may vary from ˜8% to 10% of the reactor's nominal power before shutdown. After reactor shutdown, the rate of heat removal by natural circulation of ambient air from the outer surface of the guard vessel wall would initially be lower than that of the decay heat generation in the core. The difference would be partially stored in the large sodium mass in the primary vessel (Table I) and partially removed by heat pipes to TE energy conversion modules of the auxiliary power system. Thus, the peak temperature of liquid sodium in the primary vessel after reactor shutdown would remain well below its boiling point (˜1156 K) by an acceptable margin.

Another feature of some embodiments of the present invention is that the hot air riser on the outside of the guard vessel wall has a long chimney to enhance its circulation by natural convection. The hot air riser is insulated from the intake duct to minimize heat losses to incoming cold air and maximize the driving pressure for natural circulation. Within a few days after shutdown, natural circulation of ambient air along the surface of the guard vessel would remove not only the decay heat generated in the core, but also some of the sensible heat stored earlier in the liquid sodium in the primary vessel. The temperatures of the in-vessel liquid sodium and the reactor's primary and guard vessel walls would then decrease gradually with time. This fully passive backup system for removing the decay heat from the core enhances reactor safety.

FIG. 1 shows a core design with a UN fuel enrichment of 17.65%. In an alternate embodiment, as shown in FIG. 9, a core 700 with a UN fuel enrichment of 16.95% or less may be provided. The design is similar to the other cores described above except that the thirty six fuel assemblies are encircled by a ring 704 of DUN blanket assemblies. Blanket assemblies 704 may use the designs described above. As will be noticed, the prior steel corners are replaced by partial hexagonal DUN assemblies to fully blanket the fuel assemblies. In yet another alternate embodiment, as shown in FIG. 10, a core 800 with a UN fuel enrichment of 15.70% may be provided. The design is similar to cores described above except that the thirty six fuel assemblies are encircled by a ring 804 of BeO blanket assemblies which may use the designs described above. As will be noticed, the prior steel corners are replaced by partial hexagonal BeO assemblies to fully blanket the fuel assemblies.

Neutronic analyses of the reactor was undertaken using the Monte Carlo neutron transport code MCNP5. The performed criticality calculations without reaction rate tallies used 20,000 source particles per history and 50 skipped and 9,00 active histories. Those performed with reaction rate tallies used 20,000 source particles per history and 50 skipped and 5,000 active histories. The calculations of the cold-clean reactivity assume uniform temperature of 400 K throughout the reactor core. Those of the hot-clean reactivity are at the calculated temperatures in the various regions of the reactor core such as the UN fuel pellets, HT-9 cladding, liquid Na and the core BeO and HT-9 structures. The temperatures vary with the nominal power of the reactor (10-100 MWₜₕ).

The performed neutronic analyses investigated the effects of using different materials for the follower rods in the two control systems of the reactor on the cold- and hot-clean reactivity and the reactivity shutdown margin. Varied is the material (BeO, HT-9 and DU) of the followers for the B₄C rods in the central assembly for emergency shutdown and in the fifteen B₄C rods in the reactor control system. Also investigated were the effects of using HT-9 and DUN corner assemblies in the radial blanket, which was described above as the 4^{th} ring in the core both on the clean reactivity and the shutdown margin as well as the reactivity worth of the thickness of the HT-9 core barrel wall up to 20 cm.

To avoid distorting the neutrons flux profile in the core and remove the tally dependence on k_{eff}, the calculations of the neutron reaction rate and flux tallies were performed with the reactor core critical and at hot condition (k_{eff}=1). The neutron energy spectrum in the critical hot-clean core was also determined. In the calculations of the neutron energy spectrum, the fuel composition and power production in the UN fuel bundles in each of the three rings of the driver core were tracked independently using MCNPX version 2.7.0 code. This code also tracked the fuel depletion in the core throughout the reactor's operation life, when fully depleting the hot-clean excess reactivity. The calculations were repeated at reactor nominal thermal powers of 10-100 MWₜₕ and critical (k_{eff}=1.0) hot conditions.

The base design parameters for the reactor included a chimney height of 8 m. UN fuel enrichment of 17.65%, HT-9 core barrel wall-thickness of 10 cm, and DUN radial blanket with HT-9 steel corner assemblies. In addition, the B₄C rods in the central assembly for safety shutdown and in the fuel assemblies in the 1^{st} and 2^{nd} rings of the driver core have BeO followers as discussed above. The neutronic calculations of reactor varied one base design parameter at a time.

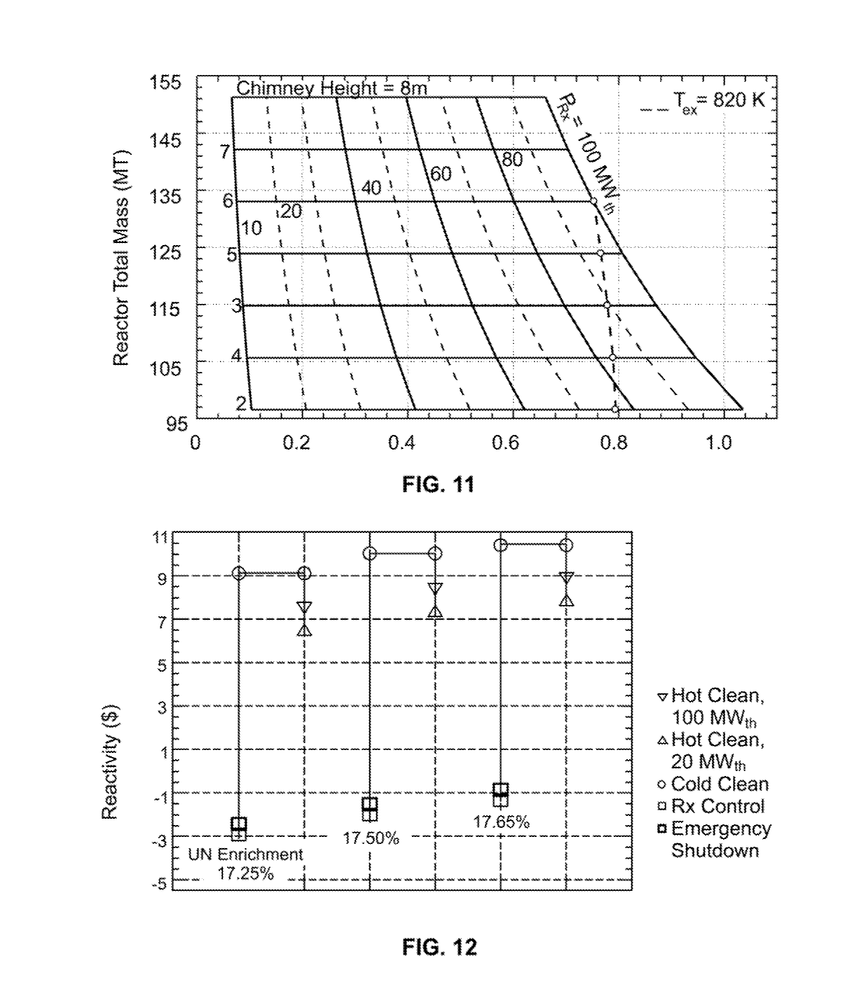

As indicated earlier, for the natural circulation cooled reactor at a given nominal thermal power and sodium inlet temperature to the core of 610 K, increasing the in-vessel chimney height increases the liquid sodium flow rate through the core and decreases its exit temperature as shown in FIG. 11. A decrease in sodium exit temperature increases the hot-clean excess reactivity that, in turn, increases the operation cycle length of the reactor, without refueling. Such an effect increases as the thermal power of the reactor increases as FIG. 11 also shows.

FIG. 12 compares the calculated hot and cold clean excess reactivity of the reactor with different materials of the followers to the B₄C rods in the reactor's emergency shutdown and control systems. Also calculated in each case is the reactivity shutdown margin at cold-clean condition. The results shown in FIG. 12 of the hot-clean reactivity are for the reactor's thermal powers of 20 and 100 MWₜₕ and the corresponding temperatures of the core structure, liquid Na and UN fuel with an 8 m chimney height.

The temperatures, calculated separately, are used to adjust densities of the UN fuel and core structure materials, core dimensions and neuron cross-sections, including resonance broadening, in the neutronic and fuel depletion analyses and lifetime estimates. The height of the reactor core increases when hot and as well as the diameters of the fuel rods and the dimensions of the core and the BeO and HT-9 shrouds for the core assemblies. In addition, the density of the liquid Na in the reactor vessel decreases and its total volume increases. Increasing the UN fuel enrichment from 17.25% to 17.65% increases the cold-clean excess reactivity but reduces the reactivity shutdown margin. This margin varies from −$3 to −$2.5 at a fuel enrichment of 17.25% to −$1.75 to −$1.6 at slightly higher enrichment of 17.65% in the base design of the reactor core. These reactivity margins are more than sufficient to safely shutdown the reactor using the B₄C rods with BeO followers of either the emergency shutdown assembly or the control rods described above.

FIG. 12 also shows that for the same cold-clean excess reactivity, the hot-clean reactivity for the reactor at a nominal operating power of 20 MWₜₕ is ˜$1.0 higher than at a higher nominal power of 100 MWₜₕ. This is because the operating temperatures for the former are lower. Based on the results delineated in FIG. 12, the base case reactor design with UN fuel enrichment of 17.65% provides the largest hot-clean reactivity and maintains a sufficient reactivity shut down margin.

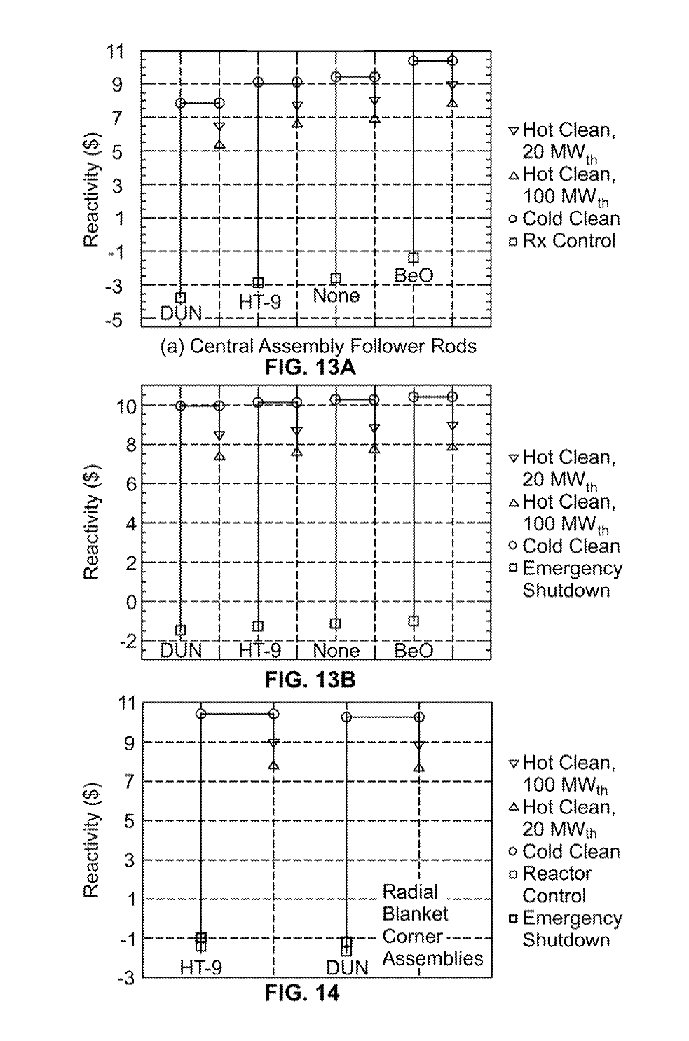

FIGS. 13A and 13B present the results of changing the material of the followers to the B₄C rods in the central assembly for emergency shutdown and to the fifteen B₄C rods for nominal reactor control, respectively. The results in FIGS. 13A and 13B include the values of the cold- and hot-clean reactivity and the cold-clean reactivity shutdown margin for the reactor. FIG. 13A is for the reactor base design, except for changing the material of the follower to the B₄C rods in the central assembly. In the base design, the material of the follower to the B₄C rods in both the reactor control and emergency shutdown systems is BeO. Results in these figures show that the reactor base design has the highest cold- and hot-clean reactivity and the smaller reactivity shutdown, which still is ˜−$1.45 in FIG. 13A and −$1.0 in FIG. 13B. The materials of the followcr rods investigated are depleted UN (DUN), HT-9 steel, and BeO. Also presented for reference are the results with no follower rods. This case gives the second higher cold- and hot-clean reactivity and a shutdown reactivity margin of −$2.6 in FIG. 13A and ˜−$1.15 in FIG. 13B. The HT-9 follower rods slightly decrease the cold- and hot-clean reactivity and increase the reactivity shutdown margin. The IDUN followers result in the lowest cold- and hot-clean reactivity and the largest reactivity shutdown margin, compared to no followers and HT-9 and BeO followers.

For the embodiment concerning a base design of the reactor, which provides HT-9 steel corner assemblies 120-125 in the radial blanket. FIG. 14 presents the results of the effect of replacing these with DUN assemblies. As FIG. 14 shows, the HT-9 steel corner assemblies slightly increase the cold- and hot-clean reactivity. They decrease slightly the cold-clean reactivity shutdown margin for each of the reactor. However, with sufficient shutdown margin (˜−$1.0) for safe operation, the slightly higher excess reactivity associated with having HT-9 corner assemblies in the radial blanket is desirable for increasing the operation life of the reactor.

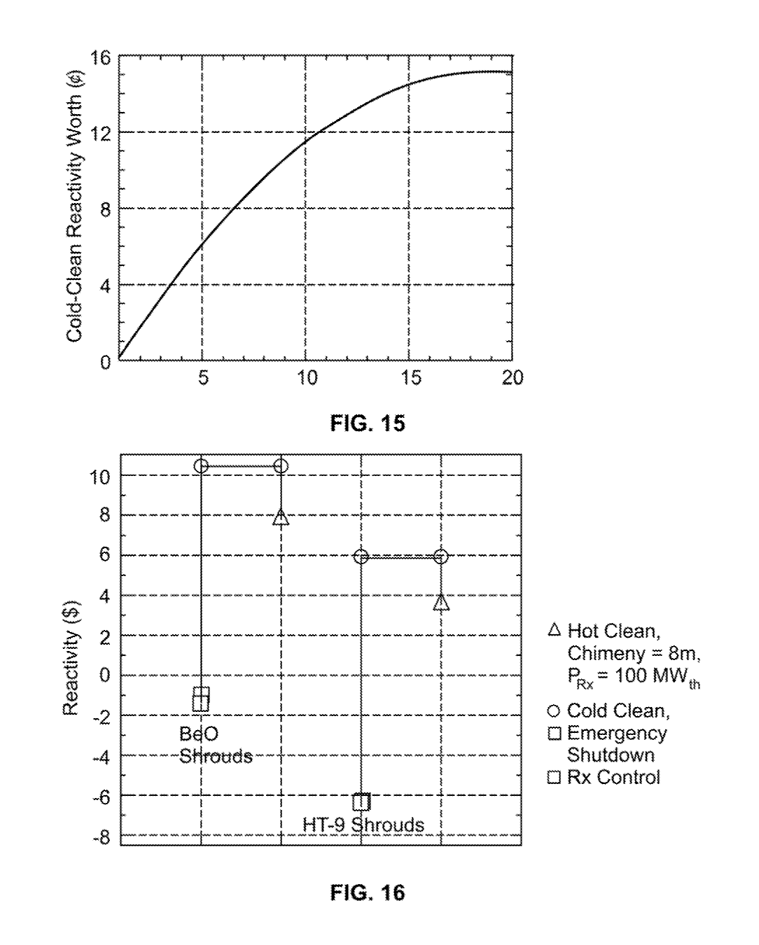

The HT-9 core barrel helps reflect leaking neutrons out of the core and could affect the reactivity of the reactor. FIG. 15 examines the reactivity worth of the core barrel wall up to a thickness of 20 cm and that of the BeO shrouds for the 36 UN fuel assemblies in the driver core. The results of FIG. 15 show that increasing the wall thickness increases the cold-clean reactivity, but only by a few to several cents. The reactivity worth of the HT-9 wall increases almost linearly with a thickness up to 7 cm, and, as a result, the rate of increase progressively decreases with increasing the wall thickness. As a compromise, the base reactor design uses a wall thickness of 10 cm. The thickness of the core barrel wall does not affect the cold-clean reactivity shutdown margin of the reactor.

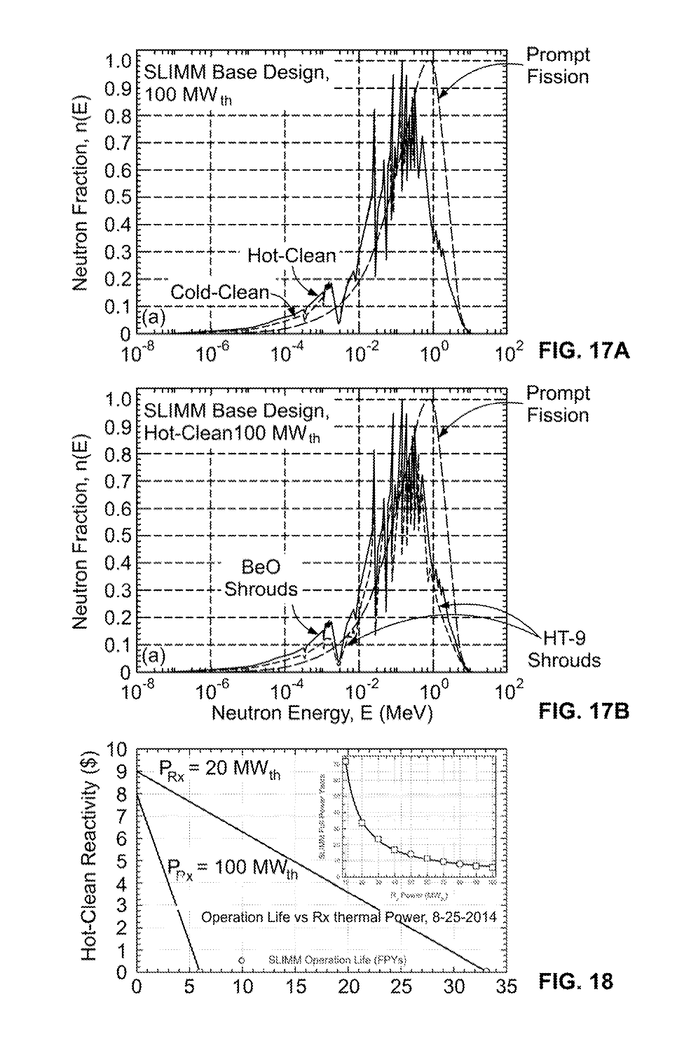

The results shown in FIG. 16 compare the calculated cold-clean reactivity for the SLIM reactor with BeO and HT-9 steel shrouds for the UN fuel assembles in the driver core. Parasitic neutron absorption is higher in HT-9 than BeO which not only produces additional neutrons by the (γ,n) and (n,2n) reactions but also increases the fraction of the low energy neutrons in the energy spectrum as shown in FIGS. 17A and 17B. With BeO shrouds (base-design) the calculated cold clean and hot clean reactivity for the reactor is $10.4 and $7.84, respectively. Replacing BeO with HT-9 in the shrouds of the fuel assemblies in the driver core decreases the cold clean and hot clean reactivity by ˜44% and ˜55% to $5.84 and $3.57, respectively as shown. In summary, using BeO shrouds for the UN fuel assemblies in the driver core increases reactivity and hence, the operation lifetime the reactor, without having to increase the UN fuel enrichment. This would be the case with HT-9 shrouds in order to achieve the same clean reactivity and reactor operation life.

FIG. 17A compares the neutron energy spectra in the reactor for the cold-clean condition and for the hot-clean conditions at a reactor thermal power of 100 MWₜₕ. The figure also includes the energy spectrum of the prompt fission neutrons for reference. Results demonstrate that the reactor core has a hard neutron spectra with most probable energy of 136 Kev as shown in FIG. 17A. The spectrum for the hot-clean conditions negligibly change with decreasing the nominal thermal power of the reactor. Those spectra for the hot-clean and cold-clean conditions are indistinguishable for neutron energy >1 keV. However, the neutron fractions at lower energies are higher for the hot clean than for the cold-clean condition.

Owing to the slight tail of the neutron energy spectra in the epithermal range, the effect of resonance broadening of the neutron cross-sections on reactivity at hot condition would be small. Other factors that affect the hot-clean reactivity are: (a) the decreases in densities of UN fuel, HT-9 cladding and core structure and other core materials and (b) the changes in the dimensions of active core and UN fuel. For example, the axial expansion of the UN fuel not only decreases the fission rate but also increases the active core height and hence neutron leakage, partially decreasing the hot-clean reactivity.

As indicated in FIG. 16, the hot-clean reactivity with BeO shrouds of the UN fuel assemblies in the driver core of SLIMM reactor is ˜75% of its cold-clean reactivity. With HT-9 shrouds, the core's hot-clean reactivity is only ˜61% of its cold-clean reactivity.

The neutron energy spectra in FIG. 17B show the effect using BeO or HT-9 shrouds of the UN fuel assemblies on the hot-clean reactivity of the reactor. With the BeO shrouds, the energy spectrum is higher than with HT-9 shrouds at all energies, particularly for those less than 25 keV and more than 0.45 MeV. The higher neutrons fraction at the low energies reflects higher fission rate and that at the higher energy reflects the contributions of the (γ,n) and (n,2n) reaction in Beryllium. The combined effect is the indicated increases in the cold- and hot-clean reactivity of the reactor with BeO shrouds for the UN fuel assemblies by $4.56 and $4.27, respectively, compared to when using HT-9 steel shrouds as shown in FIG. 16.

The hard neutron energy spectrum of the SLIMM reactor is advantageous in reducing the inventory minor actinides generated in the UN fuel during reactor operation. The effectiveness in burning minor actinides stems from the fact that the ratio of fission to the capture neutron cross sections is higher in a fast spectrum than in a thermal spectrum, such as of LWRs.

FIG. 18 compares the estimates of the operation life of the reactor, without refueling, at thermal powers of 20 to 100 MWₜₕ. The operation life estimate at the higher reactor power is ˜5.6 full-power years and ˜26.8 full-power years at the lower power. For both power levels, the hot-clean reactivity decreases practically linearly with the full-power operation time. This reactivity also decreases almost linearly with increasing the average fuel burn up in MWD/kg of uranium, irrespective of the reactor power, from 10-100 MWₜₕ. The insert in FIG. 18 shows that the reactor operation life decreases exponentially with increasing the reactor thermal power. Results also show that the reactor lifetime is 11 and 53 full-power years when operated at a nominal power of 50 and 10 MWₜₕ, respectively.

In another embodiment, the present invention provides a modular nuclear reactor comprising a reactor pressure vessel having a lower section having a first wall and a second wall and an upper section having a first wall and a second wall. The walls of the lower section and the upper section are adapted to be connectable. The second wall of the upper section defining a chimney having a first open end and an opposingly located second open end. The chimney maybe disposed in the upper section and defines a first passageway. Also provided is a second passageway disposed between the chimney and the first wall of said upper section. The upper section further includes an upper plenum in communication with the first open end of the chimney and connecting the first and second passageways of the upper section. A heat exchanger is disposed in the second passageway of the upper section. The first wall lower of said lower section is opposingly located from the second wall of the lower section to form a first passageway that is communication with the first passageway of the upper section. The second wall of the lower section defines a second passageway that is in communication with the second passageway of the upper section. A lower plenum connects the first and second passageways of said lower section. The reactor core is located within the second passageway of the lower section and is adapted to heat a heat transfer fluid by having one or more passageways in communication with the second passageway of the lower section. The first and second passageways create a circulation loop wherein a heated heat transfer fluid circulates up from the reactor core, through the chimney, through the upper plenum and downwardly past the heat exchanger, into the lower plenum and back into the core.

In other embodiments, the nuclear core includes a hexagonal shutdown drive assembly comprised of a plurality of B₄C rods with BeO followers, a first hexagonal ring of six hexagonal UN fuel assemblies surrounding the shutdown drive, a second hexagonal ring of twelve hexagonal UN fuel assemblies surrounding the first ring, a third hexagonal ring of eighteen hexagonal UN fuel assemblies surrounding the second ring, a fourth ring hexagonal ring comprised of six one-half hexagonal BeO of DUN blanket assemblies at the vertices and eighteen BeO or DUN hexagonal blanket assemblies surrounding the third ring.

The reactor may further including a plurality of heat pipes in the vessel wall to enhance air-cooling by natural circulation. An auxiliary power source driven by heat extracted from the wall of the vessel may also be used. The power source may be adapted to generate electric power. Sensors between the inner and outer vessel walls for monitoring reactor operation and to provide early warning may also be used.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A modular nuclear reactor system comprising:
a reactor pressure vessel having a lower section having a first wall and a second wall and an upper section having a first wall and a second wall;
said walls of said lower section and said upper section adapted to be connectable;
said second wall of said upper section defining a chimney having a first open end and an opposingly located second open end, said chimney disposed in said upper section and defines a first passageway;
a second passageway disposed between said chimney and said first wall of said upper section;
said upper section further including an upper plenum in communication with said first open end of said chimney and connecting said first and second passageways of said upper section;
a heat exchanger disposed in said second passageway of said upper section;
said first wall lower of said lower section opposingly located from said second wall of said lower section to form a first passageway, said first passageway in communication with said first passageway of said upper section;
said second wall of said lower section defining a second passageway, said second passageway in communication with said second passageway of said upper section;
said lower section further including a lower plenum connecting said first and second passageways of said lower section;
a reactor core located within said second passageway of said lower section, said reactor core adapted to heat a heat transfer fluid and including one or more passageways in communication with said second passageway of said lower section; and
said first and second passageways create a circulation loop wherein heated heat transfer fluid circulates up from said reactor core, through said chimney, through said upper plenum and downwardly past said heat exchanger, into said lower plenum and into said passageways of said core.

2. The nuclear reactor of claim 1 wherein said heat exchanger is a helix coil disposed on said chimney.

3. The nuclear reactor of claim 1 wherein said core includes a shutdown drive surrounded by a first, second and third ring of fuel assemblies comprising rods of fissile material.

4. The nuclear reactor of claim 3 wherein said fuel assemblies are surrounded by a ring comprised of a plurality of DUN or BeO blanket assemblies and a plurality of steel or BeO corner assemblies.

5. The nuclear reactor of claim 1 wherein said core includes a hexagonal shutdown drive assembly comprised of a plurality of B₄C rods with BeO followers, a first hexagonal ring of six hexagonal UN fuel assemblies surrounding said shutdown drive, a second hexagonal ring of twelve hexagonal UN fuel assemblies surrounding said first ring, a third hexagonal ring of eighteen hexagonal UN fuel assemblies surrounding said second ring, and a fourth hexagonal ring comprised of six hexagonal steel corner assemblies at the vertices and eighteen hexagonal DUN blanket assemblies surrounding said third ring.

6. The nuclear reactor of claim 5 wherein said six fuel assemblies of said first ring include a central B₄C control rod with a BeO follower and said nine fuel assemblies of said second ring include a central B₄C control rod with a BeO follower.

7. The nuclear reactor of claim 1 wherein said core includes a hexagonal shutdown drive assembly comprised of a plurality of B₄C rods with BeO followers, a first hexagonal ring of six hexagonal UN fuel assemblies surrounding said shutdown drive, a second hexagonal ring of twelve hexagonal UN fuel assemblies surrounding said first ring, a third hexagonal ring of eighteen hexagonal UN fuel assemblies surrounding said second ring, a fourth ring hexagonal ring comprised of six one-half hexagonal DUN blanket assemblies at the vertices and eighteen DUN hexagonal blanket assemblies surrounding said third ring.

8. The nuclear reactor of claim 7 wherein said six fuel assemblies of said first ring include a central B₄C control rod with BeO follower and said nine fuel assemblies of said fuel assemblies of said second ring include a central B₄C control rod with BeO follower.

9. The nuclear reactor of claim 1 wherein said core includes a hexagonal shutdown drive assembly comprised of a plurality of B₄C rods with BeO followers, a first hexagonal ring of six hexagonal UN fuel assemblies surrounding said shutdown drive, a second hexagonal ring of twelve hexagonal UN fuel assemblies surrounding said first ring, a third hexagonal ring of eighteen hexagonal UN fuel assemblies surrounding said second ring, a fourth ring hexagonal ring comprised of six one-half hexagonal BeO blanket assemblies at the vertices and eighteen BeO hexagonal blanket assemblies surrounding said third ring.

10. The nuclear reactor of claim 9 wherein said six fuel assemblies of said first ring include a central B₄C control rod with BeO follower and said nine fuel assemblies of said fuel assemblies of said second ring include a central B₄C control rod with BeO follower.

11. The nuclear reactor of claim 5 wherein each fuel assembly contains a plurality of fuel rods, each of said fuel rods contained in a cladding having scalloped interior walls configured to surround said fuel rods and to provide a passageway in communication with said second passageway of said lower section, said fuel rods arranged in a triangular lattice with a Pitch-to-Diameter ratio of 1.2.

12. The nuclear reactor of claim 11 wherein each fuel rod is comprised of an elongated housing having a plenum at the distal end followed by a first DUN or BeO axial blanket, followed by UN pellets, and followed by a second DUN or BeO axial blanket at the proximal end.

13. The nuclear reactor of claim 7 wherein each fuel assembly contains a plurality of fuel rods, each of said fuel rods contained in a cladding having scalloped interior walls configured to surround said fuel rods and to provide a passageway in communication with said second passageway of said lower section, said fuel rods arranged in a triangular lattice with a Pitch-to-Diameter ratio of 1.2.

14. The nuclear reactor of claim 13 wherein each fuel rod is comprised of an elongated housing having a plenum at the distal end followed by a first DUN or BeO axial blanket, followed by UN pellets, and followed by a second DUN or BeO axial blanket at the proximal end.

15. The nuclear reactor of claim 9 wherein each fuel assembly contains a plurality of fuel rods, each of said fuel rods contained in a cladding having scalloped interior walls configured to surround said fuel rods and to provide a passageway in communication with said second passageway of said lower section, said fuel rods arranged in a triangular lattice with a Pitch-to-Diameter ratio of 1.2.

16. The nuclear reactor of claim 15 wherein each fuel rod is comprised of an elongated housing having a plenum at the distal end followed by a first DUN or BeO axial blanket, followed by UN pellets, and followed by a second DUN or BeO axial blanket at the proximal end.

17. The nuclear reactor of claim 1 further including a plurality of heat pipes in said vessel wall to enhance air-cooling by natural circulation.

18. The nuclear reactor of claim 1 further including an auxiliary power source driven by heat extracted from the wall of said vessel to generate electric power.

19. The nuclear reactor of claim 1 further including sensors between said inner and outer vessel walls for monitoring reactor operation and to provide early warning.

20. The nuclear reactor of claim 1 further including a cover disposed over said upper plenum, said cover containing Argon gas.

21. The nuclear reactor of claim 20 wherein said cover is adapted to permit said Argon gas to be replaced with liquid sodium to increases the gap conductance thereby enhancing removal of decay heat from said reactor core.
